(19) United States
(12) Patent Application Publication
(10) Pub. No.: US 2005/0165638 A1
(43) Pub. Date: Jul. 28, 2005

(54) Cable system customized advertising

(75) Inventor: Stephen F. Piller, Toledo, OH (US)

Correspondence Address: FRASER MARTIN BUCHANAN MILLER LLC, 132C WEST SECOND STREET, PERRYSBURG, OH, 43551-1401, US

(73) Assignee: Buckeye Cablevision, Inc., Toledo, OH (US)

(21) Appl. No.: 10/762,402

(22) Filed: Jan. 22, 2004

(51) Int. Cl. G06F 17/60

(52) U.S. Cl. 705/14

(57) ABSTRACT

An automated advertising system is provided for placing a customized advertisement on a television-based network system using an internet to generate the customized advertisement. An automated advertising server includes a web-based advertising database providing a plurality of advertising categories, templates, and data fields on an internet display for an online internet user to select from and input information relating to the customized advertisement. A payment system provides billing costs based on advertising selections made by the online internet user and receives billing information for payment of the customized advertisement. A network interface provides the customized advertisement to a programming center for scheduling the customized advertisement for display on the television based-network system. A cable broadcasting office provides the customized advertisement to a site distribution for airing the customized advertisement at a scheduled air time.

### BACKGROUND OF THE INVENTION

1. Field of the Invention

The present invention relates in general to a system for providing advertising services on a distributed television-based network, and more particularly, to an automated system for purchasing personal customized advertising or messaging for display over a cable television network.

2. Description of the Related Art

Advertisements for the sale of personal items or services such as furniture, toys, cars, bicycles, garage sale, repairs, employment, or the like have generally been limited to advertisements in newspaper classified ads. Such advertisements are usually grouped together with like subject matter in a dedicated section of the newspaper.

Typically, classified advertisements in newspapers are fairly expensive since that particular section of the paper is dedicated and printed for the particular purpose of publicly announcing the sale item. Thus, the cost of advertising must cover the cost of printing the classified section and administrative costs associated with the advertisements.

Advertisements advertisers such as real estate and car dealer vehicle sellers place ads in other portions of the paper wherein the advertisements are published on the same page as news articles and are more likely to be seen by the casual reader or a person scanning through the newspaper. These advertisements usually accompany a higher cost for the location and size of the advertisement. However, real estate and dealer vehicle sellers can usually absorb the higher cost of advertising since the high cost and profit of the sale of these items and the aggregate number of units for sale usually outweigh the cost of the advertisement. Placing advertisements in this portion of the paper for single personal items are not cost-effective since the price of the advertisement will usually exceed the cost of the item itself. Even the price tag of advertising on television (i.e. television commercials) is very costly and is not affordable to a typical person selling a single item. Additionally, administrative costs are factored into the price tag of these advertisements as personnel are needed to receive the orders, compile and set-up the advertisement, edit, and layout the design of the advertisement.

### SUMMARY OF THE INVENTION

The present invention relates to an automated advertising system for enabling an online internet user to generate, design, and purchase a customized advertisement or message for display over a cable television network.

In one aspect of the invention, an automated advertising system is provided for placing a customized advertisement on a television-based network system using an internet to generate the customized advertisement. An automated advertising server includes a web-based advertising database providing a plurality of advertising categories, templates, and data fields on an internet display for an online internet user to select from and input information relating to the customized advertisement. A payment system provides billing costs based on advertising selections made by the online internet user and receives billing information for payment of the customized advertisement. A network interface provides the customized advertisement to a programming center for scheduling the customized advertisement for display on the television based-network system. A cable broadcasting office provides the customized advertisement to a site distribution for airing the customized advertisement at a scheduled air time.

### BRIEF DESCRIPTION OF THE DRAWINGS

The above objects and advantages of the invention will become readily apparent to those skilled in the art from reading the following detailed description of a preferred embodiment of the invention when considered in the light of the accompanying drawings, in which:

FIG. 1 is a block diagram of an automated advertising system for placing adds on television-network based system using the internet according the to present invention.

FIG. 2 is an illustration of a customized advertisement on a programming lineup cable channel according to the present invention.

FIG. 3 is an illustration of a website for specifying and purchasing the customized advertisement according to the present invention.

FIG. 4 is an illustration of advertisement templates for customizing the customized advertisement according to the present invention.

FIG. 5 is an illustration of information fields for customizing the customized advertisement according to the present invention.

FIG. 6 is an illustration of a scheduling webpage according to the present invention.

FIG. 7 is an illustration of a checkout webpage according to the present invention.

FIG. 8 is an illustration of an advertisement search webpage according to the present invention.

FIG. 9 illustrates a flowchart for a method for generating an advertisement to be displayed on a cable-based network system according to the preferred invention.

### DETAILED DESCRIPTION OF THE PREFERRED EMBODIMENT

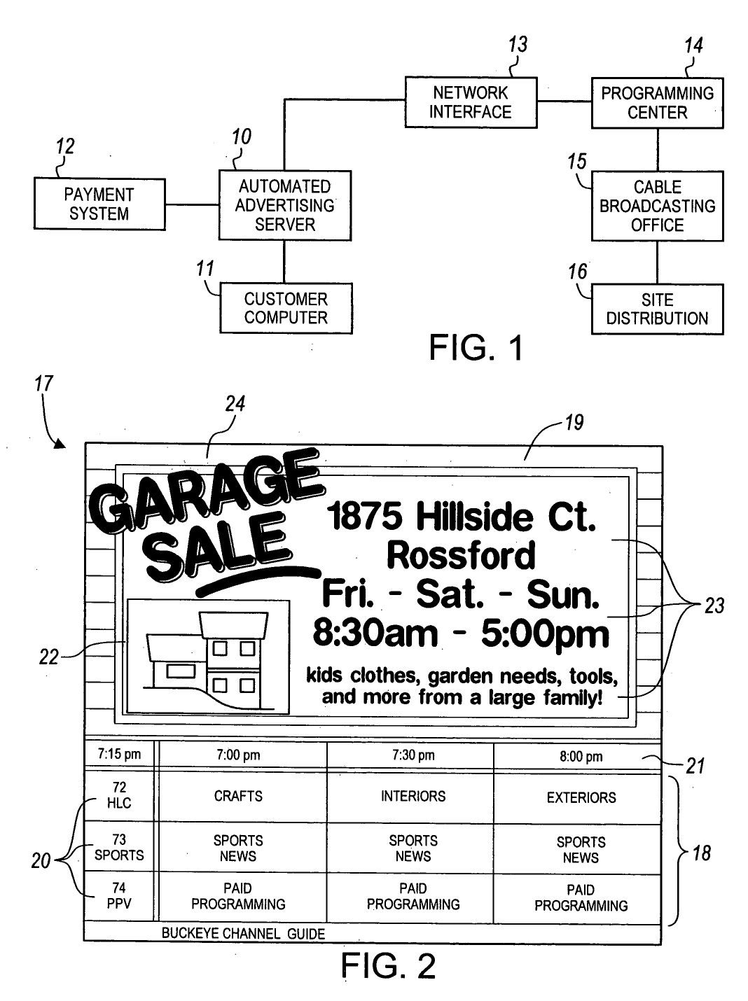

Referring now to the Drawings and particularly to FIG. 1, there is shown a block diagram of an automated advertising system for placing a customized advertisement 19 (shown in FIG. 2) on a television-based network system using the internet according the present invention. An automated advertising server 10 includes a web-based advertising database for providing and retrieving a plurality of information for processing and configuring the customized advertisement 19 according to selections and data input by an online internet user. The web-based advertising database includes advertising categories and templates from which the online internet user may select and data fields into which the online internet user may enter detailed information for creating the customized advertisement 19. The online internet user accesses the automated advertising server 10 via an internet connection linked to the online internet user's computer 11 or similar device. Selections are made with regard to the design, layout, and format of the customized advertisement 19 as well as the input of information relating to a sale item, service, announcement, or event that is to be advertised. A payment system 12 is also coupled to the automated advertising server 10 for retrieving information as to the method of payment and the billing information required to complete an advertising transaction such as credit card billing information. The automated advertising server 10 is coupled to a network interface 13 providing a gateway between the automated advertising server 10 and a server or computer at a programming center 14. The network interface 13 allows the automated advertising server 10 and the programming center 14 to share information. The network interface can be an ethernet connection, a LAN, a token ring, or other connections. The programming center 14 receives the customized advertisement including the number of times the customized advertisement has been ordered to air and schedules the customized advertisement 19 to be displayed on the television-based network system at scheduled air times. The programming center 14 will then transmit the video/audio content of the customized advertisement 19 and the designated air times to the cable broadcasting office 15. The cable broadcasting office 15 will provide the customized advertisement 19 to one or more site distribution for airing the customized advertisement 19 at the scheduled air time.

FIG. 2 illustrates a channel lineup display 17 including an advertisement according to a cable-based system network. The lower portion of the screen includes a channel lineup listing 18 for television programming provided by the cable network. The channel lineup listing 18 is a dedicated channel which provides continuous current and future programming content for each respective channel provided by a cable network provider. The channel lineup listing 18 typically displays a set of channels 20 on one display (i.e. 3 channels) for an allocated period of time 21 before scrolling to a next set of channels. The upper portion of the screen displays the customized advertisement 19 created and customized by a customer placing the advertisement. The customer also selects the dates, duration, and the number of times per day that the customized advertisement 19 is to be displayed. The customized advertisement 19 includes a heading 24 generally defining the item for sale, service, event, or announcement. Detailed customized information 23 may also be included providing detailed or descriptive information such as dates, times, location, description of item for sale or services rendered, price tag, or announcement detail. Furthermore, a photograph 22 may be added to better enhance the description of the item or event warranting the advertisement. The customer placing the advertisement, unlike newspaper classified ads and other types of advertisements, has control over the design, layout, and visual appearance of the advertisement, although the submitted advertisement is subject to final review for indecent or derogatory content.

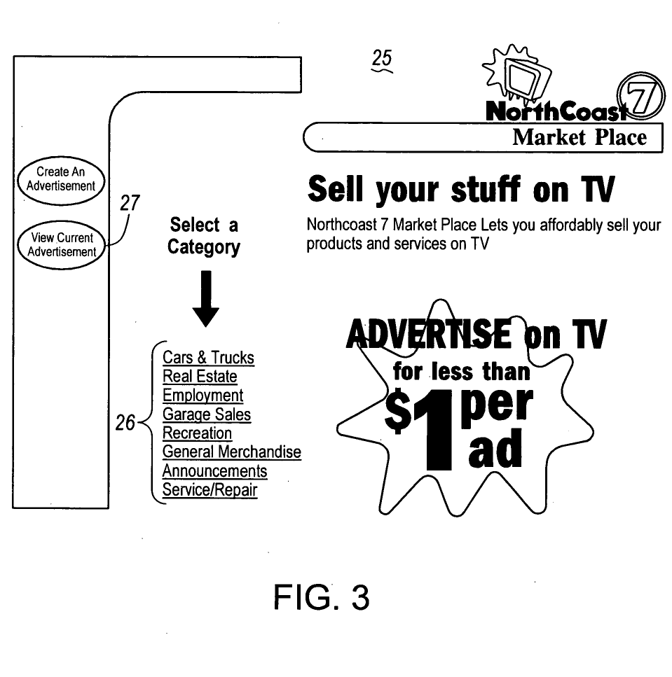

FIG. 3 illustrates a homepage 25 of a website for generating the customized advertisement 19 to be displayed on the cable-based network system according to the preferred embodiment. The homepage 25 of the website includes hyperlinks to a plurality of categories 26 to assist the customer in creating the customized advertisement 19. The plurality of categories 26 may include cars & trucks, real estate, employment, garage sales, recreation, general merchandise, announcements, and service/repair, for example. Alternatively, other categories may be added as needed. By selecting a specific category, the customer is presented with a respective category webpage relating to the specific category selected.

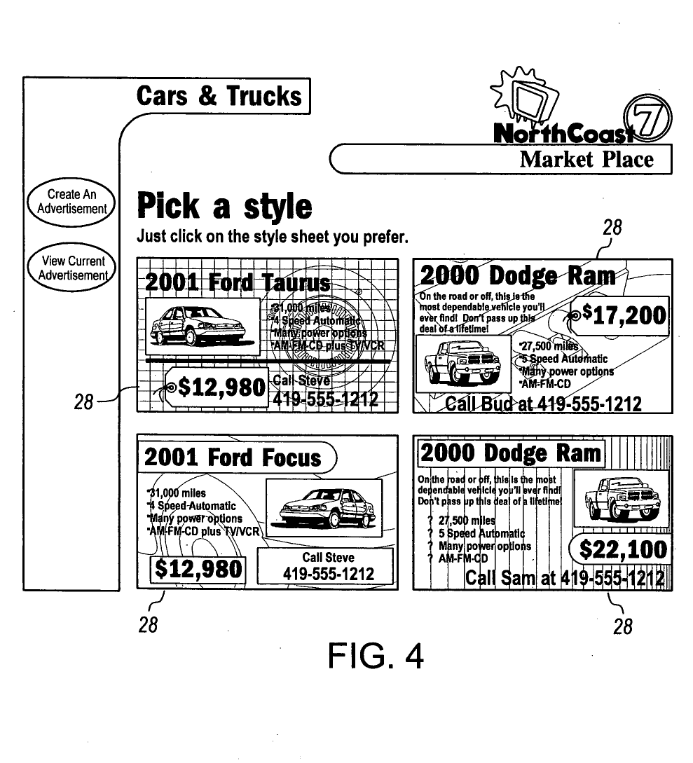

FIG. 4 illustrates a plurality of advertisement templates 28 which the customer may select to assist in creating the customized advertisement 19. A variety of choices including layout, colors, background displays, photograph locations, and text location are provided as templates to assist the customer in making a choice according to the customer's personal preference. Each of the templates is hyperlinked to a webpage for detailed data input. By selecting an image of the template, the customer navigates to the detailed data input webpage where the customer is prompted to provide descriptive information regarding the sale item, event, service, or announcement.

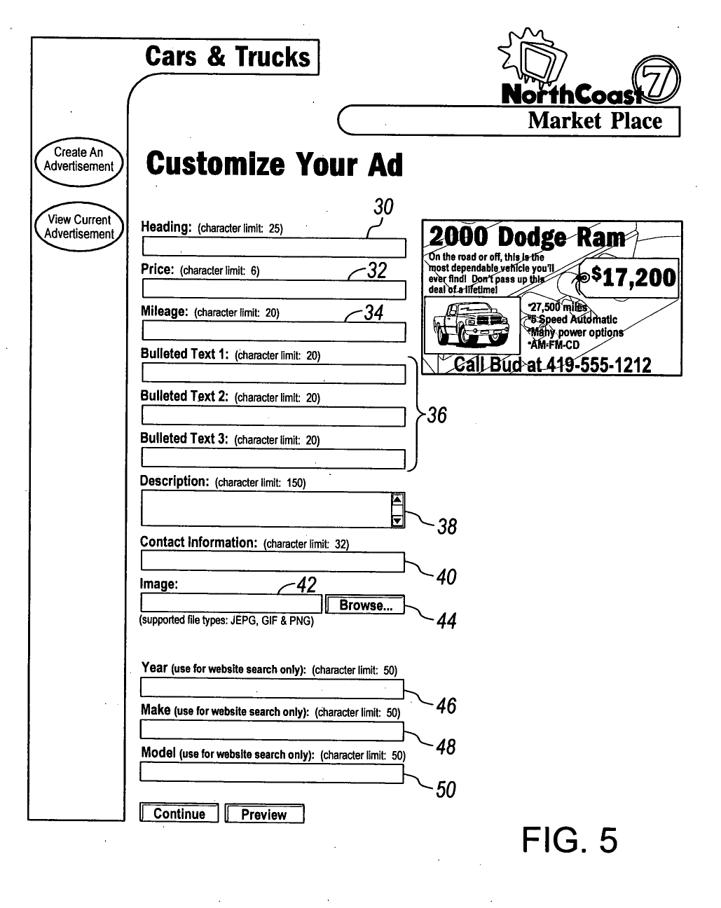

FIG. 5 illustrates a detailed data input webpage including plurality of data fields for inputting the information provided on the customized advertisement 19. The customer decides what information is displayed and the format of the information displayed on the customized advertisement 19. Limitations may be provided in each of the data fields as to a maximum number of allowable characters per field. The example category as shown in FIG. 5 is for the sale of cars & trucks. The plurality of data fields for the embodiment illustrated in FIG. 5 includes, but are not limited to, a heading data field 30 which includes a short description of the customized advertisement 19, a price data field 32, a current mileage data field 34, a bulleted text data field 36 which provides highlighted information that a prospective purchaser may desire to know up front, a description data field 38 giving detailed information that the customer may wish to provide to the prospective purchaser, a contact information data field 40 of who to contact should the prospective customer be interested, an image data field 42 which is a link to an image file (i.e. jpeg, gif, png) of the photograph 22 of the subject matter of the sale. The photograph 22 is a digital photo that is stored in a customer's computer or a location that that customer can access electronically. To assist the customer in uploading the photograph 22, a browse button is included adjacent to the image data field 42. By clicking on the browse button, this opens a file selection window for the customer. Once in the file selection window, the customer may choose which file is to be to used. The customer then selects the image file by double-clicking the file name, or by clicking on the file name and then pressing the open button to upload the image file.

Several data fields may be provided for searches that can be performed by a prospective customer visiting the website. These data fields include a model year data field 46, a make of the vehicle data field 48, and a model of the vehicle data field 50.

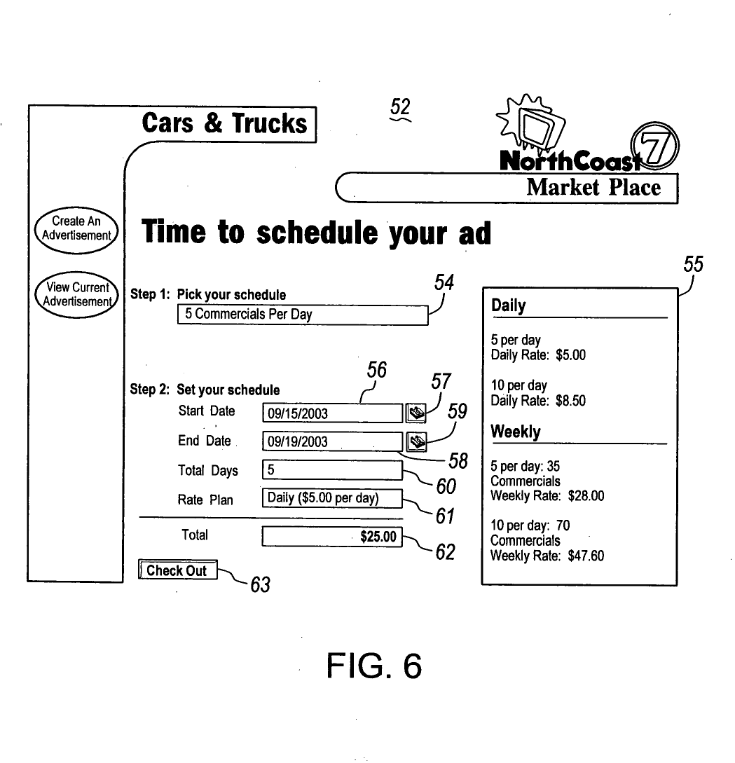

FIG. 6 illustrates a scheduling webpage 52 for providing the ad duration and number of times of day the customer chooses the customized advertisement 19 to air. A run-time data field 54 allows the customer to select the number times per day the customized advertisement will be shown. To assist the customer in selecting the per day run-time and cost, a fee schedule 55 is displayed on the scheduling webpage 52 to provide the customer with daily and weekly run-time cost options. The customer selects the number of times the customized advertisement 19 is to be shown per day from a pull-down menu in the run-time data field 54. After selecting the run-times per day, the customer then enters a start date in a start date data field 56 of when the customized advertisement 19 is to commence airing. The customer may either type the start date in the start date data field 56 or use a calendar button 57 to select a start date from a pop-up calendar and the selected start date will be filled in automatically. The customer will then enter an end date in an end date data field 58 indicating the date at which the customized advertisement 19 is to stop airing. The customer may either type the end date in the end date data field 58 or use a calendar button 59 to select an end date from a pop-up calendar and the selected end date will be filled in automatically. A total day data field 60 is automatically entered based on the selected start date and end date. A rate plan indicating the charge per day is automatically entered in a rate plan data field 61 based on the selection in the run-time data field 54. The total cost of the customized advertisement 19 duration selected by the customer is then automatically entered in a total data field 62. After entering the information in the data field, a checkout button 63 is selected to navigate the user to a next webpage to enter payment details.

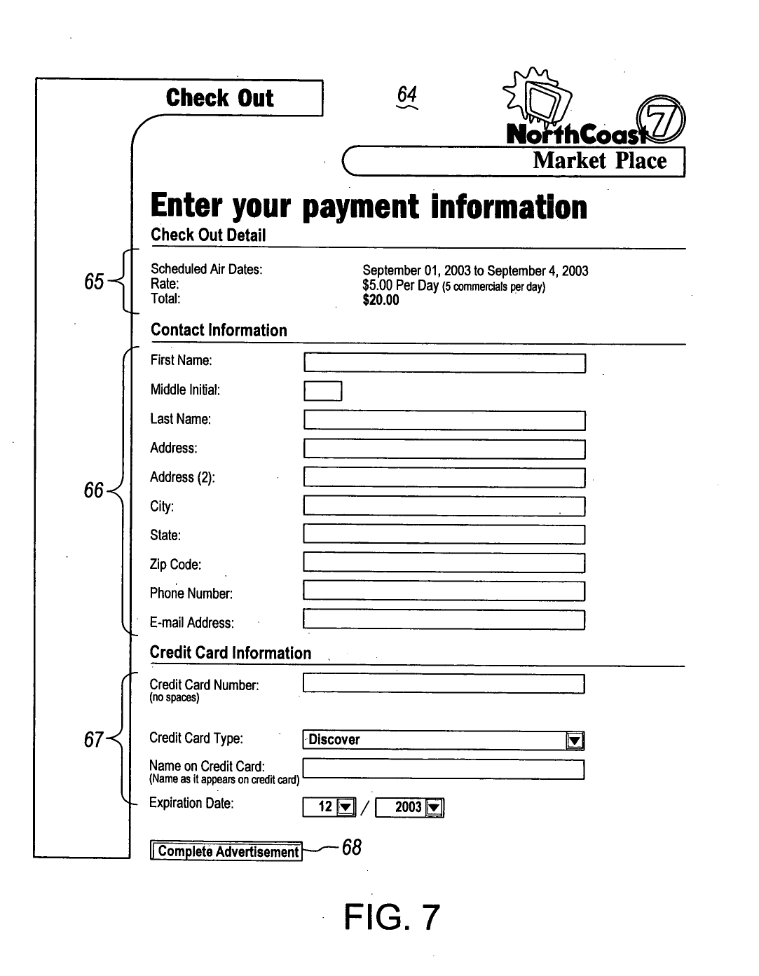

FIG. 7 illustrates a checkout webpage 64 for providing payment information for purchasing the customized advertisement 19. On a top portion of the check out webpage 64 is a summary detail 65 of the selections made by the customer. Information regarding the summary detail 65 comprises scheduled air dates of when the customized advertisement 19 is to be aired, the cost rate at which the customer is billed based on selections made, and the total cost for the customized advertisement 19. A plurality of data fields is included in a contact information section 66 for providing information as to the party being billed for the customized advertisement 19. The plurality of data fields comprises the customer's name, address, phone number, and email address. A payment section 67 is provided for obtaining information regarding the payment method for placing the customized advertisement 19. In the preferred embodiment, the method of payment is by credit card, although other methods of payment may be used. Information provided by the customer in payment data fields include credit card number, credit card type, name on the credit card, and expiration date. The credit card type and expiration date may include pull down. A “complete advertisement” button 68 may be selected after all the information has been added for completing the advertising transaction.

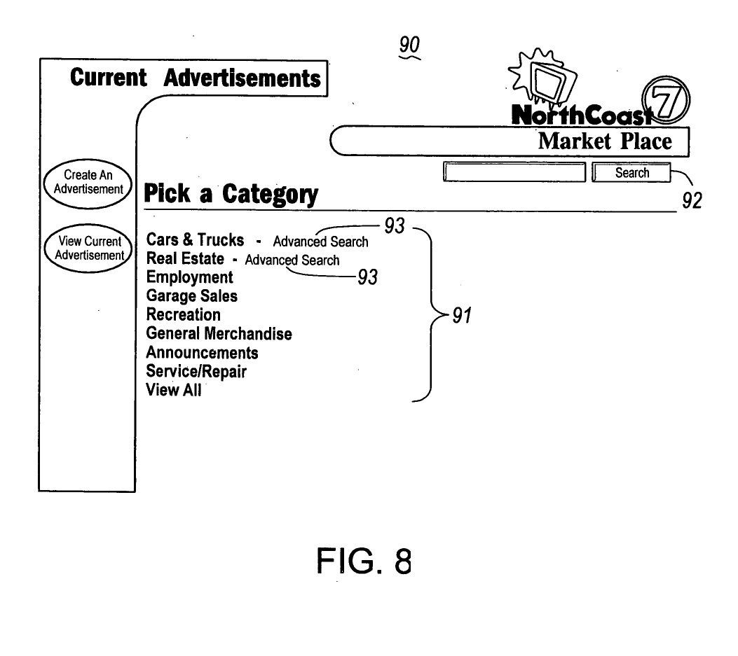

In addition to a prospective customer ordering the customized advertisement 19 on the website for advertising on the cable-based system network, a prospective buyer who has seen the customized advertisement 19 displayed on the program channel lineup may go to the website and directly search for the item of interest to review again. In FIG. 2, a view current advertisement hyperlink 27 may be selected for searching for a specific advertisement or for browsing for any particular item of interest. FIG. 8 illustrates a current advertisement webpage 90 for searching customized advertisements currently displayed on the cable-based network. The prospective buyer may either select from a plurality of viewable categories 91 for reviewing all the customized advertisements within a respective viewable category or use a keyword search 92. Each respective category may include an advance search option 93. By selecting the advanced search option 93, a prospective customer may search for specific features or requirements within a specific category. For example, for real estate, the prospective buyer may search for houses by a location, price, number of bathrooms, number of bedrooms, or a keyword search. With respect to automobiles, the prospective buyer may search for vehicles by model year, make, model, price range, or keywords.

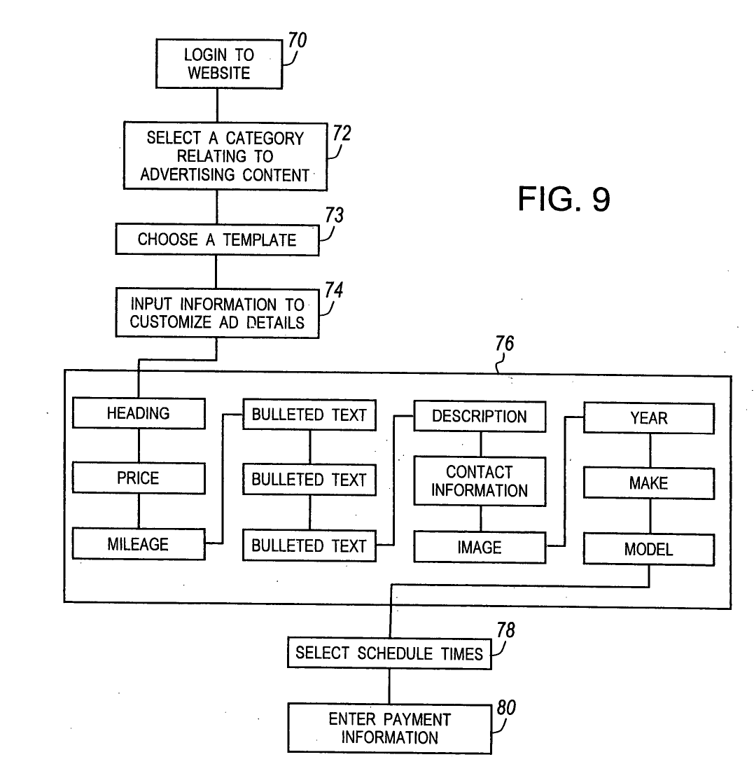

FIG. 9 illustrates an overall method for specifying and purchasing generating a customized advertisement for displaying on a cable-based television network. In step 70, a customer logs on to a homepage of a specific website (e.g., www.northcoast7.com) dedicated to purchasing advertisements on a particular cable network. A list of hyperlinks to a plurality of specific advertising categories is displayed on the homepage of the website. In step 72, the customer selects a specific category by double clicking on a respective category hyperlink relating to the customer's item for sale, event, service, or announcement. A website relating to the specific category chosen is displayed illustrating a plurality of advertising templates from which the customer may choose from. Each template offers a different layout and color scheme. In step 73, the customer selects a respective template of choice by double-clicking the respective template to generate the customized advertisement. A next website relating to the selected template is displayed which includes data fields for inputting information describing the item, event, service, or announcement. In step 74, the customer enters descriptive information within each of the data fields. The customer decides what information will be displayed and the format of the information displayed. Descriptions of information relating to the data fields include the heading, the price, bulleted text for highlighting key features, detail description, contact information, and a photograph. The photograph may be uploaded by selecting the browse button on the website for uploading an image relating to the customized advertisement. The image may be the item or house for sale, a picture of the location where the event is taking place, a picture of a person, location, or item regarding the announcement. After the data fields have been entered, the customer will click on a continue button for which a schedule website is displayed. In step 78, the customer chooses the duration that the customized advertisement is to be displayed. This includes the number of days or weekly duration the advertisement is displayed. The customer selects from a pull-down menu the desired number of times the customized advertisement is displayed in a day. The customer then enters a start date and an end date for how long the customized advertisement airs. A total cost is generated from the information entered by the customer and the total cost is displayed to the customer. The customer then selects a checkout option and is navigated to a checkout website. A summary of the detail selections made by the customer is displayed on the checkout website. Included on the checkout website is a plurality of data fields relating to contact information and payment. In step 80, the customer enters detail information regarding contact information and payment method. The customer information data fields relate to the name, address, phone, and email of the person purchasing the customized advertisement. The payment data fields relate to credit card information including credit card number, credit card type, name on credit card, and expiration date of the credit card. After detail information has been provided on the checkout website, the customer selects the complete advertisement button and the order is submitted. A duration of time may be needed to review the contents of the advertisement and to verify payment authorization before the advertisement is aired on the cable-based system network.

In accordance with the provisions of the patent statutes, the principles and modes of operation of this invention have been described and illustrated in its preferred embodiments. However, it must be understood that the invention may be practiced otherwise than specifically explained and illustrated without departing from its spirit or scope.

1. An automated advertising system for placing a customized advertisement on a television-network based system using an internet to generate said customized advertisement, the system comprising:
an automated advertising server, including a web-based advertising database for providing a plurality of advertising categories, templates, and data fields on an internet display for an online internet user to select from and input information relating to said customized advertisement;
a payment system for providing billing costs based on advertising selections made by said online internet user and for receiving billing information for payment of said customized advertisement;
a network interface for providing said customized advertisement to a programming center for scheduling said customized advertisement for display on said television based-network system; and
a cable broadcasting office for providing said customized advertisement to a site distribution for airing said customized advertisement at a scheduled air time.

2. A method of generating a customized advertisement on a television-based network system comprising the steps of:
providing access to a web-based advertising database to an on-line user;
providing a plurality of advertising categories on an internet display for said user to select a respective advertising category from, said respective advertising category relating to a subject matter of said customized advertisement;
providing at least one advertising template on said internet display for said user to select from for generating said customized advertisement;
providing data fields on said internet display for said user to input information relating to said customized advertisement;
configuring said information from said data fields to conform with said advertisement template for generating said customized advertisement; and
displaying said customized advertisement on said television-based network system.

3. The method of claim 2 wherein said television-based network system comprises a cable-based network system.

4. The method of claim 2 wherein said displaying said customized advertisement is displayed on a dedicated channel.

5. The method of claim 2 wherein said displaying said customized advertisement is displayed on a channel lineup listing.

6. The method of claim 2 wherein said internet display comprises a website.

7. The method of claim 2 wherein said advertising categories are selected from the group comprising cars, trucks, real estate, employment, garage sales, recreation, general merchandise, events, announcements, and service/repair.

8. The method of claim 2 wherein said data fields comprise text data fields for providing descriptive information relating to said customized advertisement.

9. The method of claim 2 wherein said data fields comprise a photograph data field for providing an image file relating to said customized advertisement.

10. The method of claim 2 wherein said data fields comprise scheduling data fields for selecting a duration for displaying said customized advertisement.

11. The method of claim 2 wherein said data fields comprise payment data fields for providing payment information for displaying said customized advertisement.
